(19) United States
(12) Patent Application Publication
(10) Pub. No.: US 2012/0151022 A1
(43) Pub. Date: Jun. 14, 2012

(54) SYSTEM AND METHOD FOR RAPID STAGING OF A MOBILE DEVICE

(75) Inventors: Deepak Ayyagari, Bangalore (IN); Allan Herrod, Mission Viejo, CA (US); Avinash Sanka, Bangalore (IN)

(73) Assignee: Symbol Technologies, Inc., Schaumburg, IL (US)

(21) Appl. No.: 12/965,218

(22) Filed: Dec. 10, 2010

(51) Int. Cl. G06F 15/177; G06F 13/00

(52) U.S. Cl. 709/222; 710/303

(57) ABSTRACT

A system for staging a mobile device is described. The system includes a storage device for storing a staging profile of a mobile device. A cradle is coupled to the storage device. The cradle includes at least one cradle port adapted to connect to the mobile device. The cradle receives the staging profile from the storage device and transmits the staging profile to the mobile device for application thereon.

### TECHNICAL FIELD

The invention relates generally to staging a mobile device for use on a network.

### BACKGROUND

In order for an electronic device to properly connect to a network, the device has to initially be configured to be managed and be discovered on the management system. Specifically, the device has to be staged that enables the configuration of the device. Staging is the process of quickly preparing mobile devices to deploy into an enterprise by providing settings to configure connectivity to the enterprise network, to configure access to a deployment server, and to specify the deployment to be performed.

### SUMMARY

In one aspect, the invention is embodied in a system for staging a mobile device. The system includes a storage device for storing a staging profile for a mobile device. A cradle is coupled to the storage device. The cradle includes at least one cradle port adapted to connect to the mobile device. The cradle receives the staging profile from the storage device and transmits the staging profile to the mobile device for application thereon.

In one embodiment, the storage device includes a terminal. The storage device can also be a secure digital (SD) card or a network attached storage (NAS) device. A reader can be coupled to the cradle. The reader is adapted to connect to the SD card. In one embodiment, a mobility services platform (MSP) server generates the staging profile. The staging profile can be stored on the storage device in an encrypted format.

The cradle can be coupled to the storage device through a universal serial bus (USB) interface. In one embodiment, the cradle includes a processor. The storage device can include a network attached storage (NAS) device. The cradle can be coupled to the (NAS) device through one of an Ethernet connection and a USB to Ethernet connection.

In another aspect, the invention is embodied in a method for staging a mobile device. The method includes generating a staging profile for a mobile device. The staging profile is stored in a storage device. The staging profile is selected by a mobile device connected to a cradle that is coupled to the storage device. The staging profile is transmitted through the cradle to the mobile device. The staging profile is applied to the mobile device.

The storage device can include a terminal. The storage device can include a secure digital (SD) card or a network attached storage (NAS) device. The SD card can be coupled to a reader connected to the cradle. In one embodiment, a mobility services platform (MSP) server generates the staging profile. The staging profile stored on the storage device can be encrypted. In one embodiment, the cradle is coupled to the storage device through a universal serial bus (USB) interface. In one embodiment, the storage device includes a network attached storage (NAS) device and the cradle is coupled to the (NAS) device through one of an Ethernet connection and a USB to Ethernet connection.

In yet another aspect, the invention is embodied in a system for staging a mobile device. The system includes a mobile services platform (MSP) server generating a staging profile. A storage device stores the staging profile. A cradle is coupled to the storage device. The cradle includes at least one cradle port. A mobile device is connected to the cradle port. The mobile device receives the staging profile and applies the staging profile.

In one embodiment, the mobile device selects the staging profile. The storage device can be connected to a reader that is coupled to the cradle. The staging profile can be stored on the storage device in an encrypted format. The storage device can include a secure digital (SD) card or a network attached storage (NAS) device. The cradle can be coupled to the (NAS) device through one of an Ethernet connection and a USB to Ethernet connection.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 illustrates a first system for staging a mobile device according to an exemplary embodiment.

FIG. 2 illustrates a second system for staging a mobile device according to an exemplary embodiment.

FIG. 3 illustrates a third system for staging a mobile device according to an exemplary embodiment.

FIG. 4 illustrates a fourth system for staging a mobile device according to an exemplary embodiment.

FIGS. 5A and 5B illustrate methods used for staging mobile devices according to an exemplary embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional staging, need not, and are not, described in detail herein.

One approach for staging is through an initial connection to a network component such as a staging server, relay server, etc. For example, a conventional approach for staging is using short message service (SMS) messages. In SMS staging, a services platform converts a selected staging profile into a sequence of encrypted SMS messages to the electronic device using one or more carriers. The SMS messages may be delivered to devices via email to SMS gateways provided by the carriers and/or via short message peer-to-peer protocol (SMPP) gateways contracted for with the carriers. Further conventional approaches includes bar code scanning, Ethernet based staging, and on-demand staging.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems and methods of staging devices for use on a network. The network may be any conventional type of network. For example, the network may be a local area network (LAN), a wireless LAN (WLAN), a virtual LAN (VLAN), a wide area network (WAN), a wireless WAN (WWAN), a virtual WAN (VWAN), a metropolitan area network (MAN), a storage area network (SAN), etc.

The exemplary embodiments describe the staging of a mobile device that precludes a need for the mobile device to connect to a network component. Specifically, a secure digital (SD) card and/or an external storage unit includes a staging profile that is retrieved by the mobile device for application thereof. The staging, the mobile device, the SD card, the external storage unit, the staging profile, intermediate components of the system, and a related method will be discussed in further detail below.

It should be noted that the mobile device being staged is only exemplary. The exemplary embodiments may be used for any electronic device that requires staging. For example, the electronic device may be a terminal with a connector to the intermediate components. Thus, the mobile device as described herein may refer to both mobile electronic devices and stationary electronic devices.

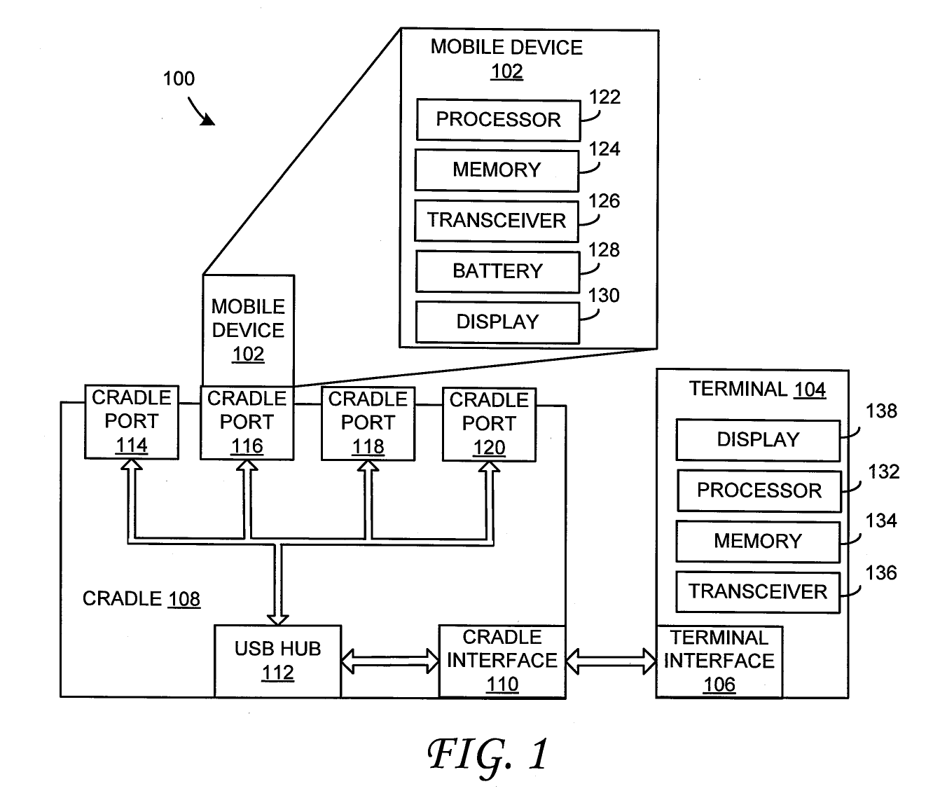

FIG. 1 illustrates a first system 100 for staging a mobile device 102 according to an exemplary embodiment. The first system 100 enables the mobile device 102 to be staged without requiring the mobile device 102 to connect to a network component such as a staging server. Furthermore, the first system 100 enables the mobile device 102 to be staged using only internal components and functionalities. The first system 100 includes a terminal 104 with a terminal interface 106 and a cradle 108 with a cradle interface 110, a universal serial bus (USB) hub 122, and a plurality of cradle ports 124, 126, 118, and 120.

The mobile device 102 may be a new un-configured mobile device with wireless connectivity capability. Thus, the mobile device 102 may not be properly configured to connect to any network such as an enterprise. In one embodiment, the mobile device 102 can be configured to connect to other networks but not configured to connect to a desired enterprise. Thus, to properly be configured, the mobile device 102 is required to be staged.

The mobile device 102 can include a processor 122 and a memory 124 for storing software applications for execution on the processor 122. The memory 124 can also store information relating to the mobile device 102 such as one or more staging profiles. The mobile device 102 can also include a transceiver 126. The transceiver 126 is configured to connect the mobile device 102 to a network. The mobile device 102 can include an operating system executing on the processor 122. The mobile device 102 can also include a battery 128 for powering the mobile device 102 and a display 130 for displaying information relating to the mobile device 102.

The terminal 104 may be any electronic device that is configured to receive and store at least one staging profile. For example, the terminal 104 can include a processor 132 and a memory 134 for storing software applications for execution on the processor 132. The memory 134 can also store information relating to the terminal 104 or the mobile device 102 such as one or more staging profiles. The terminal 104 can also include a transceiver 136. The transceiver 136 is configured to connect the terminal 104 to a network. The terminal 104 can also include one or more interfaces 106, such as a universal serial bus (USB) port interface.

A remote server can be configured to host a mobility service platform (MSP) application. The MSP application generates staging profiles that can be stored in the memory 134 of the terminal 104. The terminal 104 can also include a display 138 for displaying a graphical user interface (GUI) or any information relating to a network, the terminal 104, and/or the mobile device 102. The terminal 104 can be coupled to the remote MSP server with transceiver 136. In one embodiment, the terminal 104 can be coupled to the remote MSP server through the cradle 108.

The terminal 104 may provide enhancements to a console user interface (UI) for a staging process. For example, the MSP console UI application residing on the remote MSP server may include an option to select one or more staging profiles for a local storage mode. Thus, the staging profiles may be saved locally on the memory 134 of the terminal 104. Furthermore, the staging profiles stored locally may be in a format that is appropriate for the staging according to the exemplary embodiments as will be described in further detail below.

According to an exemplary embodiment, the MSP application may create an encoded file (e.g., a ZIP file) representing a staging profile and enable storage of the encoded file locally on the terminal 104. In an embodiment in which the MSP application resides on a remote server, the terminal 104 may connect to the MSP server to retrieve the encoded file.

Once the terminal 104 stores the staging profiles, the terminal interface 106 may be utilized to connect to the cradle 108 via the cradle interface 110. The connection may be, for example, a USB interface. However, it should be noted that any connection may be used to enable communication between the terminal 104 and the cradle 108. According to the exemplary embodiment, the cradle 108 includes the plurality of cradle ports 114, 116, 118, and 120. Thus, the cradle 108 may include the USB hub 122 for data exchange between the cradle interface 110 and the cradle ports 130-145. However, it should be noted that if the cradle 108 includes only a single cradle port, the cradle 108 may not include the USB hub 112.

When the mobile device 102 is disposed in one of the cradle ports such as cradle port 116, data may be exchanged between the terminal 104 and the mobile device 102 via the above described intermediate components. The exchange of data between the terminal 104 and the mobile device 102 may be performed using any conventional means such as ActiveSync® from Microsoft Corporation. Thus, it may be assumed that the terminal 104 and the mobile device 102 are both configured with a common exchange means. It should be noted that the connection of the cradle 108 may be readily recognized by the terminal 104 via the cradle interface 110 and the terminal interface 106. Therefore, the terminal 104 may prepare the data exchange accordingly. It should also be noted that the mobile device 102 may include further conventional functionalities to receive the staging profile such as a USB mode driver and USB physical driver. These functionalities may enable the connection between the mobile device 102 and the cradle 108.

According to the exemplary embodiment of FIG. 1, the connection between the terminal 104 and the cradle 108 may launch a specified utility for performing the data exchange of the staging profile. For example, the functionalities may include an auto-run file that launches the staging utility. Upon launching, the staging utility may detect that one or more valid staging profiles in the form of binary large objects (BLOBs) are present on the terminal 104. The staging utility may subsequently prompt a user of the mobile device 102 as to whether one or more of the staging profiles are to be used for staging the mobile device 102. When the user selects at least one of the staging profiles, the staging utility may retrieve the corresponding staging profile BLOB(s) from the terminal 104 and pass a proper command to a rapid deployment client to process the retrieved staging profile BLOB(s).

It should be noted that the above exemplary embodiment enables a single mobile device to be staged at a time. As the utility requires inputs from the user regarding which staging profiles are to be applied, the single mobile device is staged while other mobile devices that may be disposed within the cradle ports are pending. Once the staged mobile device disconnects, for example, from ActiveSync® (e.g., suspended, removed from cradle port, etc.), the terminal 104 may connect to another mobile device.

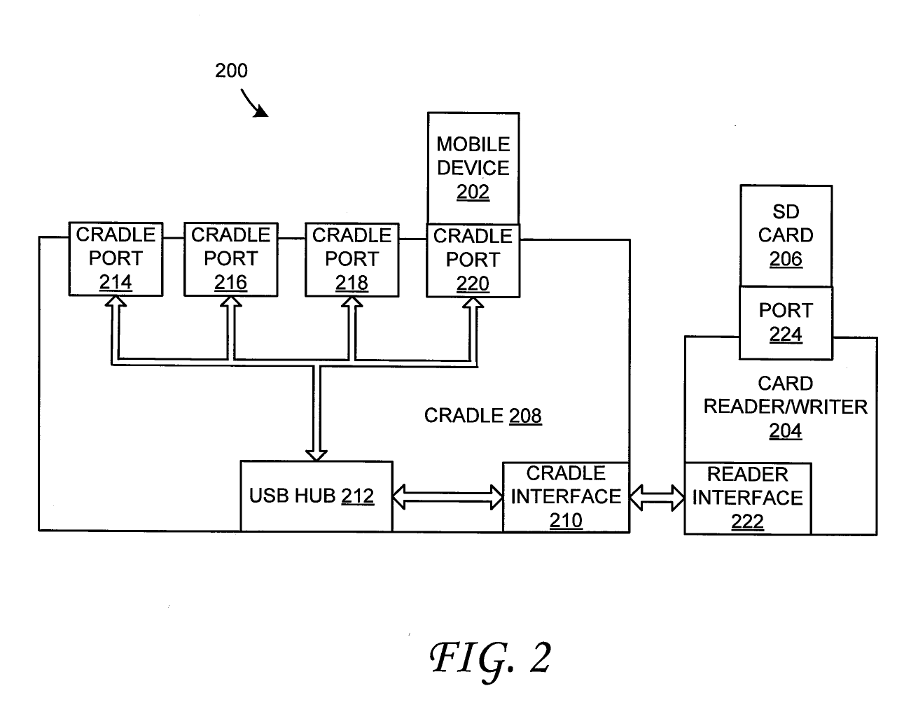

FIG. 2 illustrates a second system 200 for staging a mobile device 202 according to an exemplary embodiment. The second system 200 also enables the mobile device 202 to be staged without requiring the mobile device 202 to connect to a network component such as a staging server. The second system 200 also enables the mobile device 202 to be staged using only internal components and functionalities. The second system 200 includes a card reader/writer 204 that is configured to receive a SD card 206 and a cradle 208 with a cradle interface 210, a USB hub 212, and a plurality of cradle ports 214, 216, 218, and 220. It should again be noted that the mobile device 202 requires staging such as the mobile device 102 of FIG. 1.

The cradle 208, the cradle interface 210, the USB hub 212, and the cradle ports 214, 216, 218, and 220 may be substantially similar to those described above with reference to FIG. 1. The card reader 204 may be an external component that is configured to connect to the cradle 208 via a reader interface 222. The connection may be substantially similar to those used to connect the terminal 104 to the cradle 108 of FIG. 1. The card reader 204 may include a port 224 to receive the SD card 206 therein. The SD card 206 may be any secure storage device. The SD card 206 may be moved between multiple devices. Thus, prior to the SD card 206 being disposed in the port 224 of the card reader 204, data may be stored including the above described functionalities for initiating the staging utility. The SD card 206 may further store the plurality of staging profiles that may be available.

According to the exemplary embodiment of FIG. 2, the receiving of the SD card 206 in the card reader 204 may launch the staging utility for performing the data exchange of the staging profile. The SD card 206 may further include the auto-run file that launches the staging utility. Upon launching, the staging utility may detect that one or more valid staging profile BLOBs are present on the SD card 206. Subsequently, a substantially similar process may occur as in FIG. 1 where a user is presented with a list of available staging profiles and a selection of one of the staging profiles is made. The corresponding staging profile BLOBs may be retrieved from the SD card 206 with a proper command passed to the staging utility for the rapid deployment client to process the retrieved staging profile BLOBs.

It should be noted that according to the exemplary embodiment of FIG. 2, the mobile device 202 may support a USB host mode. The interface between the mobile device 202 and the cradle 208 may pass through the USB signals required for host mode. The cradle interface 210 may also support USB host mode. Thus, the cradle 208 may grant a single mobile device exclusive control of the cradle interface 210 at any time. The mobile device 202 may include a USB host mode driver via a USB physical driver to perform USB client discovery over the cradle interface 210. The host mode driver may discover the card reader 204 and load the USB ATA card driver to support it. The USB ATA card driver may detect the SD card 206 and mount a FAT file system to provide access to the contents of the SD card 206. The staging utility may subsequently access the SD card 206 via the file system. In a substantially similar manner as FIG. 1, when the staged mobile device 206 closes the SD card 206, the cradle 208 may grant exclusive control of the cradle interface 210 to another mobile device.

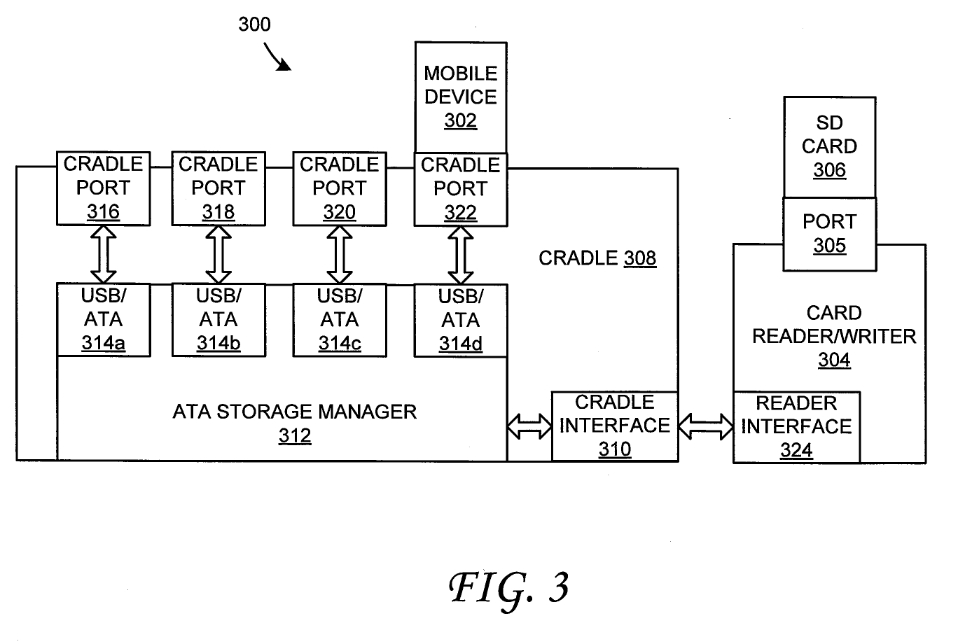

FIG. 3 shows a third system 300 for staging a mobile device 302 according to an exemplary embodiment. The third system 300 also enables the mobile device 302 to be staged without requiring the mobile device 302 to connect to a network component such as a staging server. The third system 300 also enables the mobile device 302 to be staged using only internal components and functionalities. The third system 300 includes substantially similar components as the second system 200 of FIG. 2. The third system 300 includes a card reader/writer 304 having a port 305 that is configured to receive a SD card 306 and a cradle 308 with a cradle interface 310, an ATA storage manager 312 with a plurality of USB/ATA emulators 314a, 314b, 314c, 314d, and a plurality of cradle ports 316, 318, 320, and 322. It should again be noted that the mobile device 302 requires staging such as the mobile device 202 of FIG. 2.

The card reader 304, the reader interface 324, the SD card 306, the cradle 308, the cradle interface 310, and the plurality of cradle ports 316, 318, 320, and 322 may be substantially similar to those described above with reference to the system 200 of FIG. 2. In contrast to the second system 200, the third system 300 may include the ATA storage manager 312. The ATA storage manager 312 may act as a USB host and have exclusive control of the cradle interface 310. The ATA storage manager 312 may discover the card reader 304 and the SD card 306 plugged into the port 305. The ATA storage manager 312 may mount a FAT file system to provide access to the contents of the SD card 306.

The cradle ports 316, 318, 320, and 322 may each be connected to the USB/ATA emulators 314a-d, respectively. The USB/ATA emulators 314a-d may look to the mobile device in the correspond cradle port such as the mobile device 302 in the cradle port 322 as if it were the card reader 304 with the SD card 306 disposed therein. The mobile device 302 may include a USB host mode driver that discovers the emulated USB ATA reader and load the USB ATA card driver to support it. The USB ATA card driver may detect the SD card 306 and mount a fat file system to provide access to the contents of the SD card 306. The staging utility may access the SD card 306 via the file system. The ATA storage manager 312 may coordinate requests received from multiple devices via the plurality of USB/ATA emulators 314a-d. The ATA storage manager 312 may perform access to the SD card 306 to service the requests received from the plurality of USB/ATA emulators 314a-d. The ATA storage manager 312 may optionally cache data to improve performance by avoiding the need to access the same data from the SD card 306 repetitively. Therefore, the third system 300 may function in a substantially similar manner as the second system 200 but further enable multiple mobile devices to be staged concurrently.

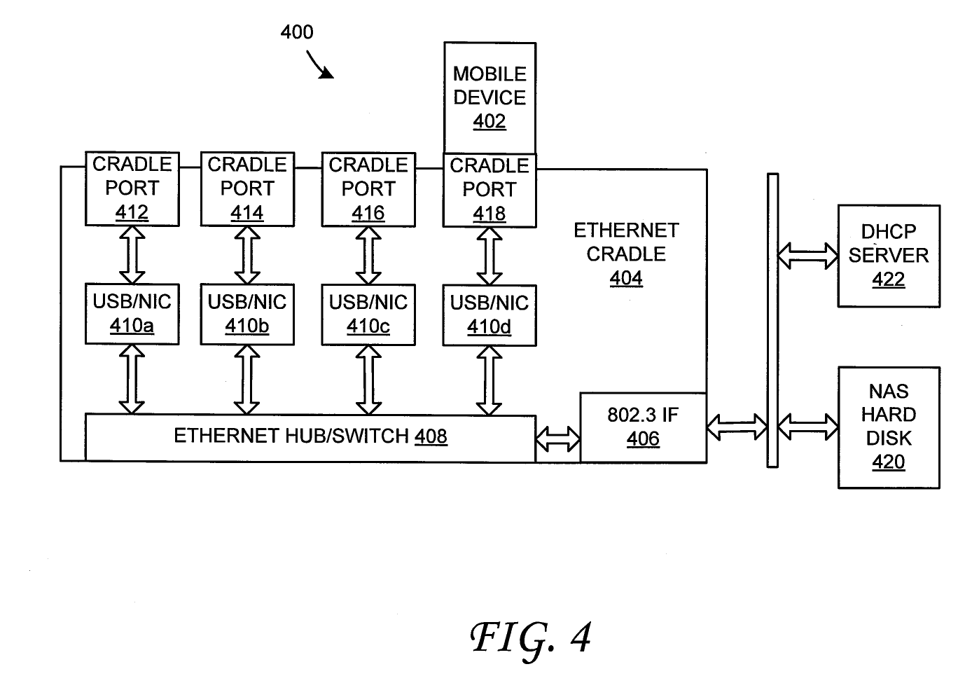

FIG. 4 shows a fourth system 400 for staging a mobile device 402 according to an exemplary embodiment. The fourth system 400 also enables the mobile device 402 to be staged without requiring the mobile device 402 to connect to a network component such as a staging server. The fourth system 400 includes a Ethernet cradle 404 with a cradle interface 406, an Ethernet hub/switch 408, a plurality of USB network interface controllers (NICs) 410a, 410b, 410c, 410d, and a plurality of cradle ports 412, 414, 416, and 418. It should again be noted that the mobile device 402 requires staging such as the mobile device 302 of FIG. 3.

The cradle 404 may be configured to support multiple concurrent access to an external network component such as a network attached storage (NAS) hard disk 420. The NAS hard disk 420 may be connected to the cradle 404 via the cradle interface 406 which may be, for example, a 802.3 RJ45 Ethernet port. The mobile device 402 may support USB host mode and the interface between the mobile device 402 and the cradle port 418 may pass through the USB signals required for the host mode. The cradle interface 406 may also support the USB host mode. The mobile device 402 may include a USB host mode driver via a USB physical driver that performs USB client discovery over the cradle interface 406. The host mode driver may discover the USB NICs 410a-d and load remote network driver interface specifications (RNDIS) driver to support it. The RNDIS driver may interact with the USB NICs 410a-d to gain access to the Ethernet interface (e.g., cradle interface 406) via the Ethernet hub/switch 408.

The mobile device 402 may acquire a TCP/IP stack to obtain an IP address from a DHCP server 422. The staging utility may access a file or folder on the NAS hard disk 420 by using a UNC path to the desired file or folder. The device common internet file system (CIFS) redirector may coordinate access to the files and folders on the NAS hard disk 420 by using the CIFS protocol via the TCP/IP stack. Thus, the fourth system 400 also enables multiple mobile devices to be staged concurrently.

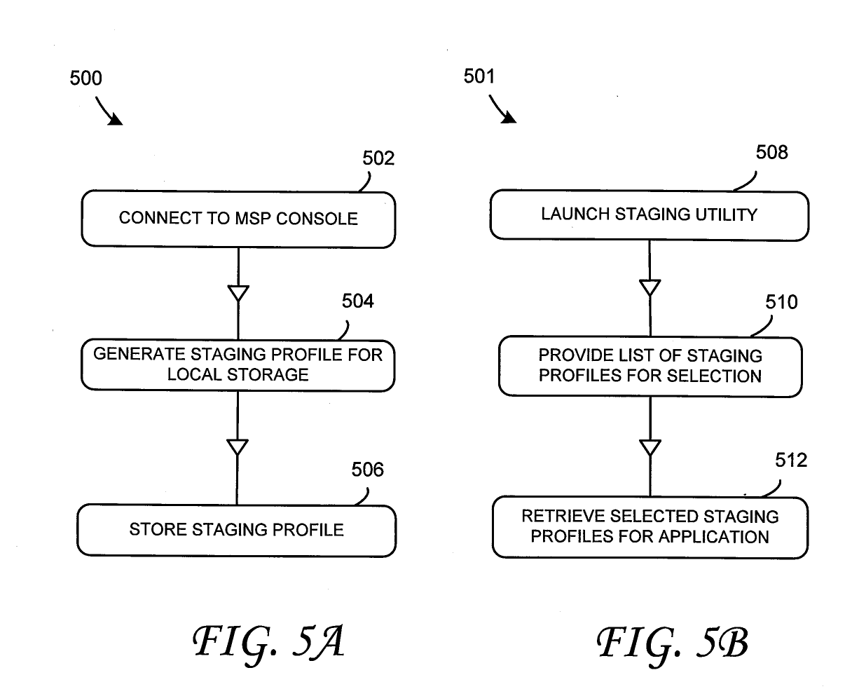

FIGS. 5A and 5B illustrate methods 500, 501 used for staging a mobile device without requiring the mobile device to connect to a network component according to an exemplary embodiment. Specifically, FIG. 5A illustrates an exemplary method 500 for generating and storing a staging profile. FIG. 5B illustrates an exemplary method 501 for staging a mobile device. The methods 500, 501 will be described with reference to the first system 100 of FIG. 1, the second system 200 of FIG. 2, the third system 300 of FIG. 3, and the fourth system 400 of FIG. 4.

Referring to FIG. 5A, in step 502, a preparatory step includes logging into a MSP server. In step 504, a staging profile may be generated by the MSP server. In step 506, the staging profile may be selected to be stored locally. As discussed above, the staging profile may be encoded and stored in a local device. For example, in the first system 100, the encoded staging profile may be stored in the terminal 104; in the second system 200, the encoded staging profile may be stored in the SD card 206; in the third system 300, the encoded staging profile may be stored in the SD card 306; and in the fourth system 400, the encoded staging profile may be stored in the NAS hard disk 420.

Referring to FIG. 5B, in step 508, the staging utility may be initiated. As discussed above, the staging utility may be initiated automatically. For example, in the first system 100, the connection established between the terminal 104 and the cradle 108 may execute an auto-run file that initiates the staging utility. In another example, in the second system 200 and the third system 300, the SD card 206/306 may include the auto-run file so that reception of the SD card 206/306 in the card reader 204/304 may initiate the staging utility. In yet another example, in the fourth system 400, the disposition of the mobile device 402 in the cradle port 418 may indicate to the cradle 404 that the mobile device 402 requires staging, thereby initiating the staging utility.

In step 510, the staging utility provides a list of the available staging profiles for the user of the mobile device to select. In step 512, the staging utility retrieves the staging profile BLOB from the storage unit to apply to the mobile device. As discussed above, the local storage option of the staging profile may generate the respective staging profile BLOB. Thus, when the staging profile is selected, the staging profile BLOB may be retrieved and decoded from the terminal 104, the SD card 206, the SD card 306, and/or the NAS hard disk 420.

The exemplary embodiments allow a mobile device to be staged without ever requiring the mobile device to connect to a network component or requiring any other conventional modes of staging. According to a first exemplary embodiment, a plurality of staging profiles may be received at a terminal that connects to a cradle. A staging utility may determine selected staging profiles to be applied to the mobile device.

According to a second exemplary embodiment, a plurality of staging profiles may be stored in a SD card that is disposed in a card reader that connects to a cradle. Through a USB hub, the mobile device may be staged one at a time. According to a third exemplary embodiment, a plurality of staging profiles may be stored in a SD card that is disposed in a card reader that connects to a cradle. Through a ATA storage manager, multiple mobile devices may be staged concurrently. According to a fourth exemplary embodiment, a cradle may connect to network components and have the staging utility retrieve selected staging profiles from a NAS hard disk. In each exemplary embodiment, the mobile device is only required to be disposed in a cradle port of the cradle. The mobile device is not required to connect to a network component to facilitate staging.

Those skilled in the art will understand that the above described exemplary embodiments may be implemented in any number of manners, including, as a separate software module, as a combination of hardware and software, etc. For example, the staging utility may be a program containing lines of code that, when compiled, may be executed on a processor.

In general, the processor can include processing logic configured to carry out the functions, techniques, and processing tasks associated with the operation of the mobile device. Furthermore, the steps of a method or algorithm described in connection with the embodiments disclosed herein may be embodied directly in hardware, in firmware, in a software module executed by the processor, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus described herein. The non-processor circuits may include, but are not limited to, a radio receiver, a radio transmitter, signal drivers, clock circuits, power source circuits, and user input devices. As such, these functions may be interpreted as steps of a method to perform the mobile device staging described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A system comprising:
a storage device storing a staging profile for a mobile device; and
a cradle that is coupled to the storage device, the cradle including at least one cradle port adapted to connect to the mobile device, the cradle receiving the staging profile from the storage device and transmitting the staging profile to the mobile device for application thereon.

2. The system of claim 1, wherein the storage device comprises a terminal.

3. The system of claim 1, wherein the storage device comprises a secure digital (SD) card.

4. The system of claim 3, further comprising a reader coupled to the cradle, the reader adapted to connect to the SD card.

5. The system of claim 1, wherein a mobility services platform (MSP) server generates the staging profile.

6. The system of claim 1, wherein the staging profile is stored on the storage device in an encrypted format.

7. The system of claim 1, wherein the cradle is coupled to the storage device through a universal serial bus (USB) interface.

8. The system of claim 1, wherein the cradle furthers comprises a processor.

9. The system of claim 1, wherein the storage device comprises a network attached storage (NAS) device.

10. The system of claim 9, wherein the cradle is coupled to the (NAS) device through one of an Ethernet connection and a USB to Ethernet connection.

11. A method comprising:
generating a staging profile for a mobile device;
storing the staging profile in a storage device;
selecting the staging profile with a mobile device connected to a cradle that is coupled to the storage device;
transmitting the staging profile through the cradle to the mobile device; and
applying the staging profile to the mobile device.

12. The method of claim 11, wherein the storage device comprises a terminal.

13. The method of claim 11, wherein the storage device comprises a secure digital (SD) card.

14. The method of claim 13, further comprising connecting the SD card to a reader coupled to the cradle.

15. The method of claim 11, wherein a mobility services platform (MSP) server generates the staging profile.

16. The method of claim 11, further comprising encrypting the staging profile stored on the storage device.

17. The method of claim 11, wherein the cradle is coupled to the storage device through a universal serial bus (USB) interface.

18. The method of claim 11, wherein the storage device comprises a network attached storage (NAS) device.

19. The method of claim 18, wherein the cradle is coupled to the (NAS) device through one of an Ethernet connection and a USB to Ethernet connection.

20. A system comprising:
a mobile services platform (MSP) server generating a staging profile;
a storage device for storing the staging profile;
a cradle that is coupled to the storage device, the cradle including at least one cradle port; and
a mobile device connected to the cradle port, the mobile device receiving the staging profile and applying the staging profile.

21. The system of claim 20, wherein the mobile device selects the staging profile.

22. The system of claim 20, further comprising a reader coupled to the cradle, the storage device connected to the reader.

23. The system of claim 20, wherein the staging profile is stored on the storage device in an encrypted format.

24. The system of claim 20, wherein the storage device comprises a secure digital (SD) card.

25. The system of claim 20, wherein the storage device comprises a network attached storage (NAS) device.

26. The system of claim 25, wherein the cradle is coupled to the (NAS) device through one of an Ethernet connection and a USB to Ethernet connection.
